(19) United States
(12) Patent Application Publication
(10) Pub. No.: US 2022/0066477 A1
(43) Pub. Date: Mar. 3, 2022

(54) METHOD, ELECTRONIC DEVICE, AND SYSTEM FOR CONTROLLING COOPERATIVE OPERATIONS OF UNMANNED AERIAL VEHICLES

(71) Applicant: SZ DJI TECHNOLOGY CO., LTD., Shenzhen (CN)

(72) Inventors: Renli SHI, Shenzhen (CN); Zhenhao HUANG, Shenzhen (CN); Zhaoliang PENG, Shenzhen (CN); Jinsong LI, Shenzhen (CN)

(73) Assignee: SZ DJI TECHNOLOGY CO., LTD., Shenzhen (CN)

(21) Appl. No.: 17/524,617

(22) Filed: Nov. 11, 2021

Related U.S. Application Data
(63) Continuation of application No. PCT/CN2019/095191, filed on Jul. 9, 2019.

(51) Int. Cl. G05D 1/10; G05D 1/00; G01C 11/02; B64C 39/02; B64D 1/18; B64D 47/08

(52) U.S. Cl. CPC G05D 1/104; G05D 1/0094; G01C 11/02; B64C 39/024; B64C 2201/141; B64D 47/08; B64C 2201/123; B64C 2201/127; B64D 1/18

(57) ABSTRACT

A method, an electronic device, and a system for controlling cooperative operations of unmanned aerial vehicles are disclosed. The method includes: determining a plurality of sub-area blocks in a target area block, where a corresponding to-be-performed task is set for each sub-area block; for the sub-area block, determining, from a plurality of unmanned aerial vehicles that participate in task execution of the target area block, a target unmanned aerial vehicle for performing the to-be-performed task corresponding to the sub-area block; and when location information of the target unmanned aerial vehicle meets an operating condition, sending the to-be-performed task corresponding to the sub-area block to the target unmanned aerial vehicle, so that the target unmanned aerial vehicle performs the to-be-performed task.

### RELATED APPLICATIONS

This application is a continuation application of PCT application No. PCT/CN2019/095191, filed on Jul. 9, 2019, and the content of which is incorporated herein by reference in its entirety.

### TECHNICAL FIELD

The present disclosure relates to the field of automatic control technologies, and in particular, to a method, an electronic device, and a system for controlling cooperative operations of unmanned aerial vehicles.

### BACKGROUND

With the continuous development of automatic control technologies, unmanned aerial vehicles may complete aerial flight tasks and various operation tasks. For example, aerial survey unmanned aerial vehicles may perform operations such as measurement and image acquisition. For another example, plant protection unmanned aerial vehicles may be used for operations such as spraying pesticides and fertilizers. Because the unmanned aerial vehicles are facing problems such as large working areas and heavy tasks during operations, how to improve operation efficiency of the unmanned aerial vehicles is a problem that urgently needs to be solved.

### SUMMARY

The present disclosure provides a method, an electronic device, and a system for controlling cooperative operations of unmanned aerial vehicles, in order to control a plurality of unmanned aerial vehicles simultaneously and improve operation efficiency of the unmanned aerial vehicles.

According to a first aspect, the present disclosure provides a method for controlling cooperative operations of unmanned aerial vehicles, where the method includes: determining a plurality of sub-area blocks in a target area block, wherein each of the plurality of sub-area blocks corresponds to a task; for each of the plurality of sub-area blocks: determining a target unmanned aerial vehicle, from a plurality of unmanned aerial vehicles, for performing the task corresponding to the sub-area block to complete, cooperatively with other unmanned aerial vehicles of the plurality of unmanned aerial vehicles, an overall task over the target area block; and based on an operating condition associated with location information of the target unmanned aerial vehicle, sending or refraining from sending the task corresponding to the sub-area block to the target unmanned aerial vehicle.

In the method, electronic device, and system for controlling cooperative operations of unmanned aerial vehicles according to some exemplary embodiments of the present disclosure, for each of the plurality of sub-area blocks in the target area block, the target unmanned aerial vehicle for performing the task of the sub-area block is determined, and the task of the sub-area block is sent to the target unmanned aerial vehicle; and the target unmanned aerial vehicle performs the task of the sub-area block. In some exemplary embodiments of the present disclosure, the target area block is divided into the plurality of sub-area blocks, and each unmanned aerial vehicle is assigned to perform the task in each sub-area block. In this way, cooperative operations of the plurality of unmanned aerial vehicles can be implemented, and operation efficiency is improved.

### BRIEF DESCRIPTION OF THE DRAWINGS

To clearly describe the technical solutions in some exemplary embodiments of the present disclosure, the following briefly describes the accompanying drawings required for describing the exemplary embodiments. Apparently, the accompanying drawings in the following description merely show some exemplary embodiments of the present disclosure, and a person of ordinary skill in the art may still derive other drawings from these accompanying drawings without creative efforts.

FIG. 1 is a schematic diagram of a scenario of cooperative operations of a plurality of unmanned aerial vehicles according to some exemplary embodiments of the present disclosure;

FIG. 2 is a flowchart of a method for controlling cooperative operations of unmanned aerial vehicles according to some exemplary embodiments of the present disclosure;

FIG. 3 is a schematic diagram of a route of a to-be-performed task in a sub-area block according to some exemplary embodiments of the present disclosure;

FIG. 4 is another schematic diagram of a route of a to-be-performed task in a sub-area block according to some exemplary embodiments of the present disclosure;

FIG. 5 is a schematic diagram of key points on a route according to some exemplary embodiments of the present disclosure;

FIG. 6 is a flowchart of a method for controlling cooperative operations of unmanned aerial vehicles according to some exemplary embodiments of the present disclosure;

FIG. 7 is a schematic structural diagram of an electronic device according to some exemplary embodiments of the present disclosure; and

FIG. 8 is a schematic structural diagram of a system for controlling cooperative operations of unmanned aerial vehicles according to some exemplary embodiments of the present disclosure.

### DETAILED DESCRIPTION

The technical solutions in some exemplary embodiments of the present disclosure are hereinafter described clearly and in detail with reference to the accompanying drawings. Evidently, the described embodiments are only some embodiments rather than all of the embodiments of the present disclosure. All other embodiments which could be obtained by a person of ordinary skill in the art based on the embodiments of the present disclosure without creative efforts shall fall within the protection scope of the present disclosure.

In existing technologies, aerial survey unmanned aerial vehicles and plant protection unmanned aerial vehicles may face problems such as large working areas or heavy tasks during operations. Aiming to solve the problems, the present disclosure provides a method, an electronic device, and a system for controlling cooperative operations of unmanned aerial vehicles.

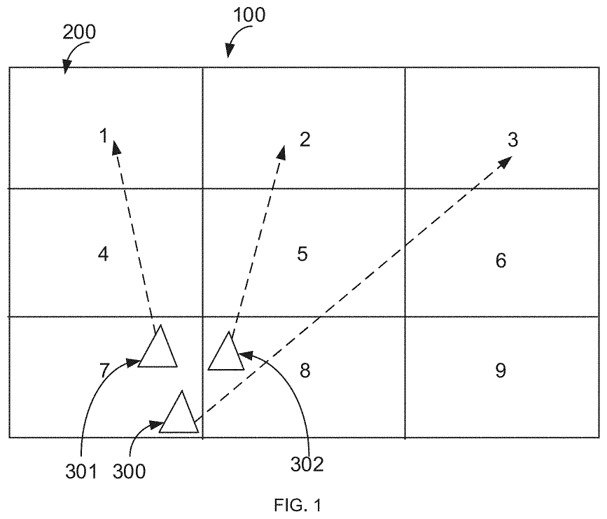

FIG. 1 is a schematic diagram of a scenario of cooperative operations of unmanned aerial vehicles according to some exemplary embodiments of the present disclosure. The unmanned aerial vehicles may be aerial survey unmanned aerial vehicles or plant protection unmanned aerial vehicles. Referring to FIG. 1, in some exemplary embodiments, when a working area is relatively large, if only one unmanned aerial vehicle is in operation to complete an overall task over the entire working area, problems such as insufficient power of the unmanned aerial vehicle, long operation time, and low efficiency may arise. Therefore, in some exemplary embodiments of the present disclosure, a target area block 100 with a large working area may be divided into a plurality of sub-area blocks 200. Each of the plurality of sub-area blocks 200 corresponds to a to-be-performed task, which may be a sub-task of the overall task of the entire working area, and the overall task may be a summation of the to-be-performed tasks corresponding to all sub-area blocks 200. The division methods may be based on an operation area, a terrain, a route, a task type, or the like. Details are not limited herein. In FIG. 1, for example, the target area block 100 may be divided into nine sub-area blocks 200, and each sub-area block 200 may correspond to a to-be-performed task. For the sub-area block 200, a target unmanned aerial vehicle for performing the to-be-performed task corresponding to the sub-area block may be determined, and the determined target unmanned aerial vehicle may perform the to-be-performed task of the sub-area block.

In FIG. 1, for example, each of a sub-area block numbered 1, a sub-area block numbered 2, and a sub-area block numbered 3 may correspond to a to-be-performed task. In some exemplary embodiments, three unmanned aerial vehicles may perform tasks of the target area block; the target unmanned aerial vehicle corresponding to the sub-area block numbered 1 may be a first target unmanned aerial vehicle 301, the target unmanned aerial vehicle corresponding to the sub-area block numbered 2 may be a second target unmanned aerial vehicle 300, and the target unmanned aerial vehicle corresponding to the sub-area block numbered 3 may be a third target unmanned aerial vehicle 302. When location information of the first target unmanned aerial vehicle 301, the second target unmanned aerial vehicle 300, and the third target unmanned aerial vehicle 302 meets an operating condition, to-be-performed tasks corresponding to the sub-area block numbered 1, the sub-area block numbered 2, and the sub-area block numbered 3 may be respectively sent to the first target unmanned aerial vehicle 301, the second target unmanned aerial vehicle 300, and the third target unmanned aerial vehicle 302, so that the first target unmanned aerial vehicle 301, the second target unmanned aerial vehicle 300, and the third target unmanned aerial vehicle 302 may perform the received to-be-performed tasks.

In some exemplary embodiments, one target unmanned aerial vehicle may correspond a plurality of sub-area blocks based on actual needs. For example, the target unmanned aerial vehicle corresponds to a sub-area block numbered 1, a sub-area block numbered 2, and a sub-area block numbered 3 may be the first target unmanned aerial vehicle 301, the target unmanned aerial vehicle corresponds to the sub-area block numbered 4 may be the second target unmanned aerial vehicle 300, and the target unmanned aerial vehicle corresponds to sub-area blocks numbered 5 to 9 may be the third target unmanned aerial vehicle 302. When location information of the first target unmanned aerial vehicle 301, the second target unmanned aerial vehicle 300, and the third target unmanned aerial vehicle 302 meets the operating condition, to-be-performed tasks corresponding to the sub-area blocks numbered 1 to 3, the sub-area block numbered 4, and the sub-area blocks numbered 5 to 9 may be respectively sent to the first target unmanned aerial vehicle 301, the second target unmanned aerial vehicle 300, and the third target unmanned aerial vehicle 302, so that the first target unmanned aerial vehicle 301, the second target unmanned aerial vehicle 300, and the third target unmanned aerial vehicle 302 may perform the received to-be-performed tasks.

In another implementation, a plurality of target unmanned aerial vehicles may be determined for one sub-area block. For example, when there are at least two discontinuous preset routes for a to-be-performed task corresponding to a sub-area block, a target unmanned aerial vehicle may be determined for each of the discontinuous preset routes. In this case, the plurality of target unmanned aerial vehicles jointly perform the to-be-performed task corresponding to the sub-area block, where the preset routes of the to-be-performed task in the sub-area block correspond to the target unmanned aerial vehicles on a one-to-one basis.

In some exemplary embodiments of the present disclosure, the plurality of sub-area blocks in the target area block may be determined, and for each of the plurality of sub-area blocks, the target unmanned aerial vehicle for performing the to-be-performed task corresponding to the sub-area block may be determined; and when the location information of the target unmanned aerial vehicle meets the operating condition, the to-be-performed task corresponding to the sub-area block may be sent to the target unmanned aerial vehicle, so that the target unmanned aerial vehicle may perform the to-be-performed task. Further, multi-thread cooperative operations of the plurality of unmanned aerial vehicles may be implemented, and operation efficiency of the unmanned aerial vehicles during large-area operations may be improved.

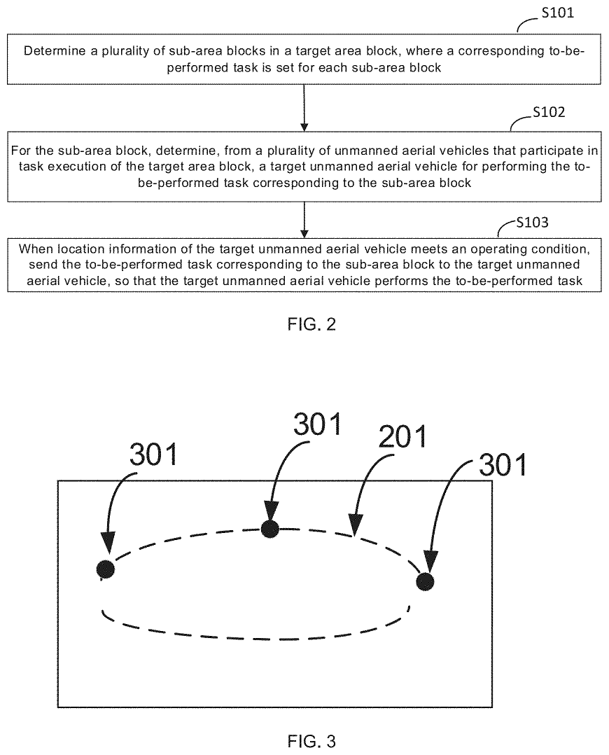

FIG. 2 is a flowchart of a method for controlling cooperative operations of unmanned aerial vehicles according to some exemplary embodiments of the present disclosure. The method may be applied to a terminal device, such as a remote control, a mobile phone, or a computer. Referring to FIG. 2, the method may include the following steps S101 to S103.

S101, determine a plurality of sub-area blocks in a target area block, where a corresponding to-be-performed task is set for each sub-area block.

In some exemplary embodiments, the target area block may be divided into the plurality of sub-area blocks, and the corresponding to-be-performed task may be set for each sub-area block; and further, a task corresponding to the target area block may be divided into a plurality of tasks for separate executions, and each task may have a preset route.

The determining of the plurality of sub-area blocks in the target area block may be obtaining pre-divided and locally stored information of the plurality of sub-area blocks in the target area block, where the information may include numbers of the sub-area blocks, areas of the sub-area blocks, shapes of the sub-area blocks, location information of the sub-area blocks, specific content of to-be-performed tasks, and the like; or may be obtaining the plurality of sub-area blocks by dividing the target area block based on actual needs. Further, in some exemplary embodiments, a timing of dividing the target area block to obtain the plurality of sub-area blocks may vary, and division may also be performed by a device other than a device performing the control method. In this case, the terminal device may obtain the information of the plurality of sub-area blocks in the target area block from the device other than the device performing the control method. Therefore, the division methods and/or division timing of dividing the target area block into sub-area blocks are not limited herein.

S102, for the sub-area block, determine, from a plurality of unmanned aerial vehicles that participate in task execution of the target area block, a target unmanned aerial vehicle for performing the to-be-performed task corresponding to the sub-area block.

In some exemplary embodiments, at least two unmanned aerial vehicles may participate in task execution of the target area block, and a sum of to-be-performed tasks corresponding to the sub-area blocks may constitute the task of the target area block.

In some exemplary embodiments, to improve operation accuracy of the unmanned aerial vehicle and avoid problems such as disorder in task execution because the unmanned aerial vehicle has a plurality of tasks at the same time, when a to-be-performed task is sent to the target unmanned aerial vehicle, only one to-be-performed task may be sent to the same target unmanned aerial vehicle each time.

S103, when location information of the target unmanned aerial vehicle meets an operating condition, send the to-be-performed task corresponding to the sub-area block to the target unmanned aerial vehicle, so that the target unmanned aerial vehicle performs the to-be-performed task.

In the method for controlling cooperative operations of unmanned aerial vehicles according to some exemplary embodiments of the present disclosure, for each of the sub-area blocks obtained by dividing the target area block, the corresponding target unmanned aerial vehicle for performing the to-be-performed task in the sub-area block may be determined; and when the location information of the target unmanned aerial vehicle meets the operating condition, the to-be-performed task corresponding to the sub-area block may be sent to the target unmanned aerial vehicle for execution. In this way, one terminal device may control the plurality of unmanned aerial vehicles to jointly perform the task of the target area block, and operation efficiency may be significantly improved.

In some exemplary embodiments of the present disclosure, before the foregoing method is performed, the plurality of unmanned aerial vehicles that participate in task execution of the target area block may first adjust their status to connectable states, so that the terminal device may establish a connection to each of the plurality of unmanned aerial vehicles; after the terminal device establishes a connection to each unmanned aerial vehicle, the terminal device may obtain and store an identifier of each unmanned aerial vehicle; and then the terminal device may send a positioning mode confirmation instruction to each unmanned aerial vehicle, so that the unmanned aerial vehicle may confirm, after receiving the positioning mode confirmation instruction, whether a current positioning mode is a specified mode, and if no, then switches the positioning mode to the specified mode.

The identifier of the unmanned aerial vehicle may be sent by the unmanned aerial vehicle to the terminal device. For example, the identifier may be a product serial number; or may be an identifier allocated by the terminal device to each unmanned aerial vehicle, where the identifier may be a number of the unmanned aerial vehicle. The terminal device may number the unmanned aerial vehicles in the order of connections established to the unmanned aerial vehicles, or may randomly allocate numbers to all the unmanned aerial vehicles after establishing connections to all the unmanned aerial vehicles. The terminal device may also directly use current location information of the unmanned aerial vehicle as the identifier of the unmanned aerial vehicle.

The specified mode may include a real-time kinematic (RTK) positioning mode. In this mode, the unmanned aerial vehicle may achieve centimeter-level positioning.

In some exemplary embodiments, a user may enable an RTK option on the terminal device to trigger the terminal device to send the positioning mode confirmation instruction to each unmanned aerial vehicle.

In some exemplary embodiments, each unmanned aerial vehicle may adjust its current positioning mode to the real-time kinematic positioning mode. In this mode, the terminal device may broadcast differential data to the plurality of unmanned aerial vehicles, so that the plurality of unmanned aerial vehicles may obtain the differential data from an RTK base station or a virtual base station, so as to achieve centimeter-level positioning. In addition, even if the unmanned aerial vehicle loses contact with the RTK base station, the unmanned aerial vehicle may still maintain positioning accuracy within 20 cm within a limited range (e.g., about half an hour), thereby ensuring safety of the plurality of unmanned aerial vehicles during cooperative operations.

In some exemplary embodiments of the present disclosure, after switching the positioning mode to the real-time kinematic positioning mode, the unmanned aerial vehicle may send current location information (e.g., location information of a takeoff point) to the terminal device, and the terminal device may receive the current location information of each unmanned aerial vehicle.

In some exemplary embodiments, for each sub-area block, after determining the target unmanned aerial vehicle for performing the to-be-performed task corresponding to the sub-area block, and further determining that the current location information of the target unmanned aerial vehicle meets the operating condition, the terminal device may send the to-be-performed task corresponding to the sub-area block to the target unmanned aerial vehicle; and after receiving the to-be-performed task, the target unmanned aerial vehicle may perform the task.

In some exemplary embodiments of the present disclosure, in the foregoing method, after the target unmanned aerial vehicle for performing the to-be-performed task corresponding to the sub-area block is determined, a route of the to-be-performed task may be determined, and location information of at least one key point on the route may be obtained. Based on a distance between the takeoff point of the target unmanned aerial vehicle and the at least one key point, whether the location information of the target unmanned aerial vehicle meets the operating condition is determined. If the location information of the target unmanned aerial vehicle meets the operating condition, the to-be-performed task corresponding to the sub-area block may be sent to the target unmanned aerial vehicle. If the location information of the target unmanned aerial vehicle does not meet the operating condition, the target unmanned aerial vehicle may move until the location of the target unmanned aerial vehicle meets the operating condition; or another target unmanned aerial vehicle may be reassigned for the sub-area block. In some exemplary embodiments of the present disclosure, when whether the location information of the target unmanned aerial vehicle meets the operating condition is determined, a distance between a point of other location information of the target unmanned aerial vehicle and the key point may be selected and used for determination. Specific settings may be performed based on actual task requirements, and are not limited herein.

In some exemplary embodiments, the route of the to-be-performed task may be preset before the target area block may be divided into the plurality of sub-area blocks, or may be set separately for each sub-area block after the target area block is divided into the plurality of sub-area blocks.

For example, a method of determining whether the location information of the target unmanned aerial vehicle meets the operating condition may include: separately calculating distances between the takeoff point of the target unmanned aerial vehicle and all the key points on the route of the to-be-performed task. When a distance between the takeoff point of the target unmanned aerial vehicle and at least one key point is shorter than a first distance, the location information of the target unmanned aerial vehicle meets the operating condition.

For example, the key points may include at least one of the following: a starting point on the route, an ending point on the route, or a point at a specified position on the route.

The point at the specified position may be a point farthest away from the takeoff point of the target unmanned aerial vehicle on the route, or if the route has a specific shape, then the point at the specified position may be a point at a corner of the specific shape. For example, when the route is a triangle, the specified point may be a vertex of the triangle. Certainly, another point on the route may also be selected as the point at the specified position based on actual needs. Details are not limited herein.

Referring to FIG. 3, in a schematic diagram of the route of the task according to some exemplary embodiments of the present disclosure, key points 301 on a first route 201 are a starting point of the route, an ending point of the route, and a midpoint of the route respectively.

In some exemplary embodiments, assuming that the key points are the starting point and ending point of the route, the following describes how to calculate the distances between the takeoff point of the target unmanned aerial vehicle and all the key points.

If coordinates of a starting point of a route in a geodetic coordinate system are (lat_A, lon_A, height_A), and coordinates of the takeoff point of the target unmanned aerial vehicle in the geodetic coordinate system are (lat_H, lon_H, height_H), a distance between the takeoff point of the unmanned aerial vehicle and the starting point of the route may be calculated by using the following formula:

Assuming that an average radius of the earth is R, the coordinates of the starting point of the route in the geodetic coordinate system and the coordinates of the takeoff point of the target unmanned aerial vehicle in the geodetic coordinate system may be converted into coordinates in an earth-centered earth-fixed coordinate system, which are respectively:

XA=(R+height_A)×cos(lat_A)×cos(lon_A),

YA=(R+height_A)×cos(lat_A)×sin(lon_A),

ZA=(R+height_A)×sin(lat_A); and

XH=(R+height_H)×cos(lat_H)×cos(lon_H),

YH=(R+height_H)×cos(lat_H)×sin(lon_H),

ZH=(R+height_H)×sin(lat_H).

The distance between the takeoff point of the unmanned aerial vehicle and the starting point of the route may be calculated by using a distance formula between two points.

In some exemplary embodiments, the distance between the takeoff point of the target unmanned aerial vehicle and at least one key point is shorter than the first distance may include two cases. In a first case, when the distances between the takeoff point of the target unmanned aerial vehicle and all the key points are all shorter than the first distance, it may indicate that power of the target unmanned aerial vehicle may be sufficient for the target unmanned aerial vehicle to perform the task.

In a second case, when the distances between the takeoff point of the target unmanned aerial vehicle and some of the key points are shorter than the first distance, it may indicate that distances between the takeoff point of the target unmanned aerial vehicle and some of the key points are longer than or equal to the first distance. In this case, first prompt information may be output, where the first prompt information may prompt the user that the target unmanned aerial vehicle may not complete all to-be-performed tasks corresponding to the sub-area block.

In some exemplary embodiments, when distances between the takeoff point of the target unmanned aerial vehicle and some of the key points are longer than the first distance, it may indicate that current power of the target unmanned aerial vehicle is insufficient for the unmanned aerial vehicle to fly over the whole route, that is, the entire task may not be completed. However, the to-be-performed task may still be sent to the target unmanned aerial vehicle, but in this case, the target unmanned aerial vehicle may only perform a part of the to-be-performed task and then needs to return. In this case, the first prompt information may be output to prompt the user to make a decision. Based on needs, the user may select the target unmanned aerial vehicle to continue performing the to-be-performed task corresponding to the sub-area, or may select another target unmanned aerial vehicle for the sub-area.

In some exemplary embodiments of the present disclosure, the method may further include: when the distances between the takeoff point of the target unmanned aerial vehicle and all the key points are longer than or equal to a second distance, it may indicate that the location information of the target unmanned aerial vehicle does not meet the operating condition. Thus, the to-be-performed task corresponding to the sub-area block is not sent to the target unmanned aerial vehicle, where the second distance is longer than the first distance.

In some exemplary embodiments, if the distances between the takeoff point of the target unmanned aerial vehicle and all the key points on the route of the to-be-performed task are longer than or equal to the second distance, it may indicate that current power of the target unmanned aerial vehicle is insufficient for the unmanned aerial vehicle to fly to the starting point or the ending point of the route of the to-be-performed task and that the operating condition is not met. In this case, second prompt information may be output, where the second prompt information may prompt the user that the target unmanned aerial vehicle may not perform the to-be-performed task corresponding to the sub-area block. In this case, the to-be-performed task corresponding to the sub-area block is not sent to the target unmanned aerial vehicle. For example, content of the second prompt information may include information such as “matching failure, task data is not sent” or “the distance is too long, task data is not sent”.

In some exemplary embodiments, the first distance and the second distance may be set based on factors such as a current battery life of the target unmanned aerial vehicle. For the same unmanned aerial vehicle, the second distance may be greater than the first distance. For different unmanned aerial vehicles, the corresponding first distance and second distance may be different. Specific values of the first distance and the second distance are not limited herein.

In some exemplary embodiments of the present disclosure, after the distances between the takeoff point of the target unmanned aerial vehicle and all the key points are calculated, all the distances may be weighted and summated based on preset weights to obtain a value of a weighted sum. If the weighted sum is shorter than a third distance, it may be determined that the location information of the target unmanned aerial vehicle meets the operating condition.

In some exemplary embodiments, the third distance may be set based on factors such as the current battery life of the target unmanned aerial vehicle. Based on different importance of different key points, different weights may be assigned to the distances between the takeoff point of the target unmanned aerial vehicle and the key points. Then whether the operating condition is met is determined based on a value obtained through weighted summation calculation and the third distance. This determining method may have higher accuracy.

In the method for controlling cooperative operations of unmanned aerial vehicles according to some exemplary embodiments of the present disclosure, the plurality of sub-area blocks in the target area block may be determined, and for each of the plurality of sub-area blocks, the target unmanned aerial vehicle for performing the to-be-performed task corresponding to the sub-area block may be determined; and when the location information of the target unmanned aerial vehicle meets the operating condition, the to-be-performed task corresponding to the sub-area block may be sent to the target unmanned aerial vehicle, so that the target unmanned aerial vehicle may perform the to-be-performed task. Further, multi-thread cooperative operations of the plurality of unmanned aerial vehicles may be implemented, and operation efficiency of the unmanned aerial vehicles during large-area operations may be improved. In addition, whether the target unmanned aerial vehicle meets the operating condition may be determined, so as to determine whether the target unmanned aerial vehicle is suitable for performing the to-be-performed task in the sub-area block. When the target unmanned aerial vehicle is too far away from the sub-area block and therefore is uncapable of completing the to-be-performed task corresponding to the sub-area block, the to-be-performed task corresponding to the sub-area block is not sent to the target unmanned aerial vehicle. In this way, the target unmanned aerial vehicle may be prevented from being assigned a task with a distance that is too long, thus avoiding the situation in which the target unmanned aerial vehicle needs to return due to insufficient power or the like before reaching the task area. This not only avoids unnecessary waste of resources, but also improves operation efficiency.

In some exemplary embodiments of the present disclosure, the to-be-performed task may include a plurality of preset routes not being continuous with respect to each other.

When a to-be-performed task corresponding to a sub-area block has at least two discontinuous preset routes, the terminal device may assign one target unmanned aerial vehicle for each of the discontinuous preset routes, respectively. When the terminal device sends the to-be-performed task to a target unmanned aerial vehicle, the to-be-performed task may include route information corresponding to the target unmanned aerial vehicle. Thus, the plurality of determined target unmanned aerial vehicles may fly based on corresponding routes and perform the to-be-performed task. Further, in some exemplary embodiments, the preset routes of the to-be-performed task in the sub-area block correspond one-to-one to the unmanned aerial vehicles for performing the task.

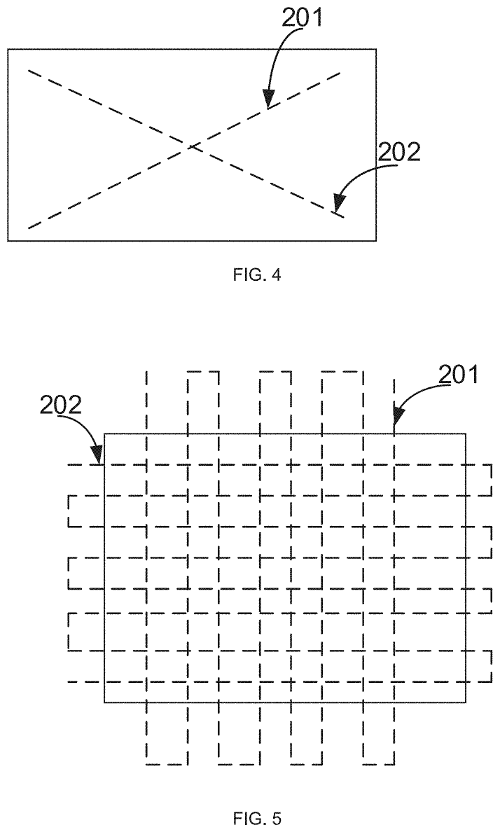

Referring to FIG. 4, the task corresponding to the sub-area block shown in some exemplary embodiments of the present disclosure may include two preset routes: a first route 201 and a second route 202. To avoid interference between unmanned aerial vehicles performing the task, flying altitude of the first route 201 and the second route 202 may be different. A specific difference between the route heights may be determined by factors such as a shape and a size of the unmanned aerial vehicle, and is not limited herein.

When the unmanned aerial vehicle is performing a surveying and mapping task, to facilitate three-dimensional modeling, image data of a surveyed and mapped area needs to be obtained from different angles. In this case, a plurality of routes may be set in a sub-area block, and unmanned aerial vehicles may be assigned to fly on the plurality of routes to obtain image data. Further, one terminal device may be used to control the plurality of unmanned aerial vehicles to acquire image data from different angles, and efficiency of surveying and mapping may be improved significantly.

In some exemplary embodiments, when the to-be-performed task is a surveying and mapping task, the to-be-performed task may instruct a photographing apparatus carried on the target unmanned aerial vehicle to perform photographing at a specified angle, such as video shooting or picture shooting. Further, after the terminal device sends the to-be-performed task to the target unmanned aerial vehicle, the target unmanned aerial vehicle may fly based on the preset route of the to-be-performed task, and may perform photo shooting at an angle specified by the to-be-performed task, and may return obtained image data to the terminal device at the same time.

For example, the specified angle of the photographing apparatus may include any specified angle within a range in which a pitch angle of the photographing apparatus is greater than or equal to −90° and less than 0°, and may include any one of the following: a pitch angle of −30°, a pitch angle of −45°, and a pitch angle of −60°.

In some exemplary embodiments of the present disclosure, when all the unmanned aerial vehicles that participate in task execution of the target area block being assigned tasks for the first time, every time a target unmanned aerial vehicle for performing a to-be-performed task of a sub-area block is determined for the sub-area block, the to-be-performed task of the sub-area block may be sent to the target unmanned aerial vehicle; or if the plurality of unmanned aerial vehicles that participate in task execution of the target area block is being assigned tasks of the target area block for the first time, after target unmanned aerial vehicles for performing to-be-performed tasks of the sub-area blocks are determined for all the sub-area blocks, the to-be-performed tasks corresponding to the sub-area blocks may be sent to the corresponding target unmanned aerial vehicles at the same time; or after to-be-performed tasks are determined for all the unmanned aerial vehicles, the tasks to be performed by all the unmanned aerial vehicles and corresponding to the sub-area blocks may be separately sent to target unmanned aerial vehicles. Therefore, in some exemplary embodiments, a timing of sending the to-be-performed task corresponding to the sub-area block to the target unmanned aerial vehicle may be determined based on actual application situations, and is not limited herein.

When a to-be-performed task corresponding to a sub-area block includes at least two preset routes not being continuous with respect to each other, one target unmanned aerial vehicle may be determined for each of the discontinuous preset routes, respectively, so that a plurality of target unmanned aerial vehicles may jointly perform the to-be-performed task corresponding to the sub-area block, where the preset routes of the to-be-performed task in the sub-area block correspond one-to-one to the unmanned aerial vehicles for performing the task. Therefore, operation efficiency of the unmanned aerial vehicles may be improved. Especially when the unmanned aerial vehicles are performing tasks such as surveying and mapping, the operation efficiency of the plurality of unmanned aerial vehicles simultaneously performing operations in the surveyed and mapped area may be significantly improved in comparison with the operation efficiency of a single unmanned aerial vehicle.

In some exemplary embodiments of the present disclosure, the method may further include the following step A10:

Step A10, when a quantity of the sub-area blocks is greater than the quantity of unmanned aerial vehicles that participate in task execution of the target area block, after determining that an unmanned aerial vehicle has completed a task, if a task of a remaining sub-area block has not been performed yet, determine, from unmanned aerial vehicles that have completed the task, a target unmanned aerial vehicle may be selected from the unmanned aerial vehicles that have completed the task to perform the task of the remaining sub-area block.

Still referring to FIG. 1, if the second target unmanned aerial vehicle 300 first completes the task and returns to the takeoff point or lands to a specified landing point, the second target unmanned aerial vehicle 300 may be assigned to a remaining sub-area block, such as the sub-area block numbered 4. If it is determined that the location information of the unmanned aerial vehicle meets the operating condition, a to-be-performed task corresponding to the sub-area block numbered 4 may be sent to the second target unmanned aerial vehicle 300. If it is determined that the location information of the unmanned aerial vehicle does not meet the operating condition, a to-be-performed task corresponding to the sub-area block numbered 4 may not be sent to the second target unmanned aerial vehicle 300.

In some exemplary embodiments, after the unmanned aerial vehicle completes the task and returns to the original takeoff point or the landing point, the unmanned aerial vehicle may be assigned a new task. In this way, a task execution process of the unmanned aerial vehicle may be separated from a task assignment process, and interference with task execution by task assignment for the unmanned aerial vehicle in the task execution process of the unmanned aerial vehicle may be avoided. In addition, the foregoing process of sending the to-be-performed task to the second target unmanned aerial vehicle 300 and the processes of performing tasks by other target unmanned aerial vehicles may be independent of each other. By way of performing operations by the unmanned aerial vehicles in turns, operation efficiency may be significantly improved.

In some exemplary embodiments of the present disclosure, the to-be-performed task of the sub-area block may be a spraying task. Further, the plurality of unmanned aerial vehicles for performing the task of the target area block in some exemplary embodiments may be plant protection unmanned aerial vehicles.

In some exemplary embodiments, the to-be-performed task used to indicate that an amount of liquid carried on the target unmanned aerial vehicle may be set based on at least one of: battery power of the target unmanned aerial vehicle, the distance between the target unmanned aerial vehicle and the key point, a flying speed of the target unmanned aerial vehicle, or a spraying speed.

In some exemplary embodiments of the present disclosure, the to-be-performed task of the sub-area block may be a surveying and mapping task. Further, the plurality of unmanned aerial vehicles for performing the task of the target area block in some exemplary embodiments may be surveying and mapping unmanned aerial vehicles.

FIG. 5 is a schematic diagram of a route in a sub-area block according to some exemplary embodiments of the present disclosure. Referring to FIG. 5, the sub-area block may include two preset routes not being continuous with respect to each other: a first route 201 and a second route 202. The two discontinuous preset routes may be orthogonal to each other. In some exemplary embodiments, to avoid mutual interference between unmanned aerial vehicles flying on the two routes, route heights of the two routes may be different.

In a route layout scenario shown in FIG. 5, if the to-be-performed task is fast oblique photographing, two unmanned aerial vehicles may need to be called at the same time. The terminal device may determine target unmanned aerial vehicles for the two preset routes respectively, and may send the to-be-performed task to each target unmanned aerial vehicle. The two unmanned aerial vehicles may fly based on the first route and the second route to perform oblique photographing operations, and may return photographing data to the terminal device. In some exemplary embodiments, flying altitudes of the first route and the second route may be different. For example, when a height difference between the two routes is three meters, a difference in resolution of photos taken is about 1 mm.

During execution of the surveying and mapping task, by setting the preset routes orthogonal with respect to each other, better achieve photographing results of an area to be surveyed may be achieved when the quantity of preset routes is small. Because there are few preset routes, less target unmanned aerial vehicles may be required to perform the task. This not only improves operation efficiency, but also saves resources.

In some exemplary embodiments of the present disclosure, in step S102 of the foregoing method, the determining, from the plurality of unmanned aerial vehicles that participate in task execution of the target area block, of the target unmanned aerial vehicle for performing the to-be-performed task corresponding to the sub-area block may include the following step B10:

Step B10: Obtain pairing information input by the user for the sub-area block, recognize an unmanned aerial vehicle identifier from the pairing information, and determine the unmanned aerial vehicle corresponding to the unmanned aerial vehicle identifier as the target unmanned aerial vehicle.

Further, in some exemplary embodiments, the user may input the pairing information for the sub-area block on the terminal device to assign the unmanned aerial vehicle to the sub-area block. There may be a plurality of ways to input pairing information, for example, inputting a number corresponding to an unmanned aerial vehicle selected by the user into a diagram of the sub-area block displayed on the terminal device, dragging an icon of an unmanned aerial vehicle to a sub-area block, or connecting and paring a selected unmanned aerial vehicle with a sub-area block by using a connection line.

The terminal device may recognize the unmanned aerial vehicle identifier from the pairing information based on user operations, and may determine the unmanned aerial vehicle corresponding to the unmanned aerial vehicle identifier as the target unmanned aerial vehicle. In some exemplary embodiments, the unmanned aerial vehicle identifier may be the number of the unmanned aerial vehicle, or may be the location information of the unmanned aerial vehicle, or the like. After the terminal device establishes a connection with the unmanned aerial vehicle, the terminal device may assign an identifier to each unmanned aerial vehicle participating in task execution, and then displays identifiers of all accessed unmanned aerial vehicles to the user. Thus, the user may directly pair the unmanned aerial vehicle identifier with the number of the sub-area block when assigning the unmanned aerial vehicle to the sub-area block.

In some exemplary embodiments of the present disclosure, the terminal device may receive working state information sent by the target unmanned aerial vehicle , and may output prompt information of the working state of the target unmanned aerial vehicle based on the information.

In some exemplary embodiments, the terminal device may output the prompt information of the working state information of the target unmanned aerial vehicle, so that the user may conveniently understand the current working state of the unmanned aerial vehicle.

For example, the working state information may include at least one of: location information, battery power information, a remaining pesticide quantity, positioning accuracy information, or current wind speed information.

Based on the location information of the unmanned aerial vehicle, a working progress of the unmanned aerial vehicle, whether the unmanned aerial vehicle deviates from the preset route, whether the task has been completed, and the like, may be determined.

Based on the battery power information of the unmanned aerial vehicle, whether the current power of the unmanned aerial vehicle may meet normal task execution of the unmanned aerial vehicle, whether the unmanned aerial vehicle needs to return for charging, and the like, may be determined.

If the unmanned aerial vehicle that performs the task is a plant protection unmanned aerial vehicle, based on the remaining pesticide quantity information of the unmanned aerial vehicle, whether the unmanned aerial vehicle may successfully perform the task and whether the unmanned aerial vehicle requires pesticide replenishment may be determined.

Based on the positioning accuracy information of the unmanned aerial vehicle, the current positioning accuracy of the unmanned aerial vehicle may be determined, and an operation error magnitude of the unmanned aerial vehicle may be further determined.

Based on the current wind speed information, a current operating environment of the unmanned aerial vehicle may be determined, and the adverse impact of the current operating environment of the unmanned aerial vehicle on the operation of the unmanned aerial vehicle may be further determined.

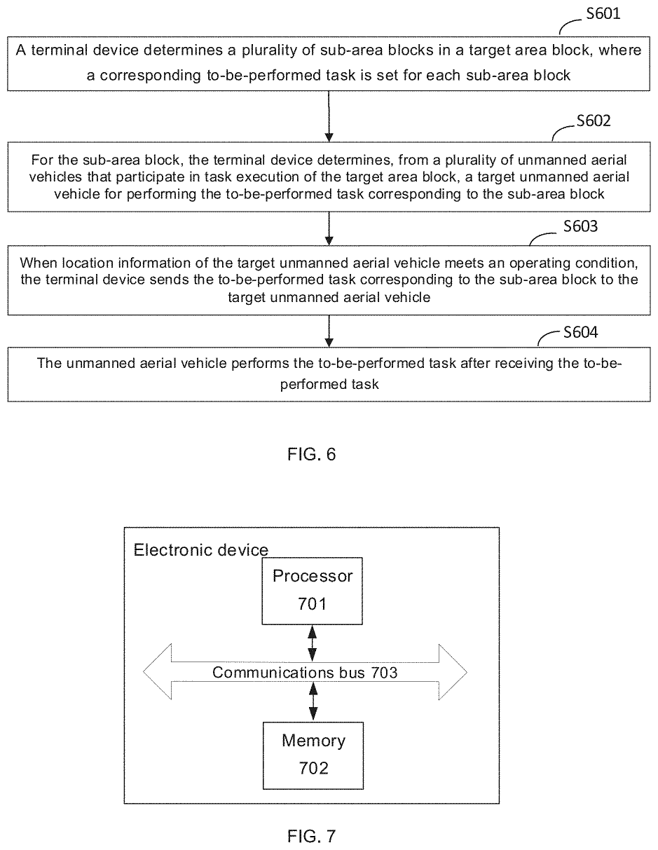

FIG. 6 is a flowchart of a method for controlling cooperative operations of unmanned aerial vehicles according to some exemplary embodiments of the present disclosure. Referring to FIG. 6, the method may include the following steps.

S601, a terminal device determines a plurality of sub-area blocks in a target area block, where a corresponding to-be-performed task is set for each sub-area block.

In some exemplary embodiments, the target area block may be divided into the plurality of sub-area blocks, and the corresponding to-be-performed task may be set for each sub-area block; and further, a task corresponding to the target area block may be divided into a plurality of tasks for separate executions, and each task may have a preset route.

The determining of the plurality of sub-area blocks in the target area block by the terminal device may be obtaining pre-divided and locally stored information of the plurality of sub-area blocks in the target area block, where the information may include numbers of the sub-area blocks, areas of the sub-area blocks, shapes of the sub-area blocks, location information of the sub-area blocks, specific content of to-be-performed tasks, and the like; or may be obtaining the plurality of sub-area blocks by dividing the target area block based on actual needs when determining an unmanned aerial vehicle for performing the task of the target area block for the target area block. Further, in some exemplary embodiments, a timing of dividing the target area block to obtain the plurality of sub-area blocks may vary, and division may also be performed by a device other than the terminal device. In this case, the terminal device may obtain the information of the plurality of sub-area blocks in the target area block from the device other than the device performing the control method. Therefore, the division methods and/or division timing of dividing the target area block into sub-area blocks are not limited herein.

S602, for the sub-area block, the terminal device determines, from a plurality of unmanned aerial vehicles that participate in task execution of the target area block, a target unmanned aerial vehicle for performing the to-be-performed task corresponding to the sub-area block.

In some exemplary embodiments, at least two unmanned aerial vehicles may participate in task execution of the target area block, and a sum of to-be-performed tasks corresponding to the sub-area blocks may constitute the task of the target area block.

In some exemplary embodiments, to improve operation accuracy of the unmanned aerial vehicle and avoid problems such as disorder in task execution because the unmanned aerial vehicle has a plurality of tasks at the same time, when sending a to-be-performed task to the target unmanned aerial vehicle, the terminal device may send only one to-be-performed task to the same target unmanned aerial vehicle each time.

S603, when location information of the target unmanned aerial vehicle meets an operating condition, the terminal device sends the to-be-performed task corresponding to the sub-area block to the target unmanned aerial vehicle.

S604, the unmanned aerial vehicle performs the to-be-performed task after receiving the to-be-performed task.

In the method for controlling cooperative operations of unmanned aerial vehicles according to some exemplary embodiments of the present disclosure, for each of the sub-area blocks obtained by dividing the target area block, the corresponding target unmanned aerial vehicle for performing the to-be-performed task in the sub-area block may be determined; and when the location information of the target unmanned aerial vehicle meets the operating condition, the to-be-performed task corresponding to the sub-area block may be sent to the target unmanned aerial vehicle for execution. In this way, one terminal device may control the plurality of unmanned aerial vehicles to jointly perform the task of the target area block, and operation efficiency may be significantly improved.

In some exemplary embodiments of the present disclosure, before the foregoing method is performed, the plurality of unmanned aerial vehicles that participate in task execution of the target area block may first adjust their status to connectable states, so that the terminal device may establish a connection to each of the plurality of unmanned aerial vehicles; after the terminal device establishes a connection to each unmanned aerial vehicle, the terminal device may obtain and store an identifier of each unmanned aerial vehicle; and then the terminal device may send a positioning mode confirmation instruction to each unmanned aerial vehicle, so that the unmanned aerial vehicle may confirm, after receiving the positioning mode confirmation instruction, whether a current positioning mode is a specified mode, and if no, then switches the positioning mode to the specified mode.

The identifier of the unmanned aerial vehicle may be sent by the unmanned aerial vehicle to the terminal device. For example, the identifier may be a product serial number; or may be an identifier allocated by the terminal device to each unmanned aerial vehicle, where the identifier may be a number of the unmanned aerial vehicle. The terminal device may number the unmanned aerial vehicles in the order of connections established to the unmanned aerial vehicles, or may randomly allocate numbers to all the unmanned aerial vehicles after establishing connections to all the unmanned aerial vehicles. The terminal device may also directly use current location information of the unmanned aerial vehicle as the identifier of the unmanned aerial vehicle.

The specified mode may include a real-time kinematic positioning mode. In this mode, the unmanned aerial vehicle may achieve centimeter-level positioning.

In some exemplary embodiments, a user may enable an RTK option on the terminal device to trigger the terminal device to send the positioning mode confirmation instruction to each unmanned aerial vehicle.

In some exemplary embodiments, each unmanned aerial vehicle may adjust its current positioning mode to the real-time kinematic positioning mode. In this mode, the terminal device may broadcast differential data to the plurality of unmanned aerial vehicles, so that the plurality of unmanned aerial vehicles may obtain the differential data from an RTK base station or a virtual base station, so as to achieve centimeter-level positioning. In addition, even if the unmanned aerial vehicle loses contact with the RTK base station, the unmanned aerial vehicle may still maintain positioning accuracy within 20 cm within a limited range (e.g., about half an hour), thereby ensuring safety of the plurality of unmanned aerial vehicles during cooperative operations.

In some exemplary embodiments of the present disclosure, after switching the positioning mode to the real-time kinematic positioning mode, the unmanned aerial vehicle may send current location information (e.g., location information of a takeoff point) to the terminal device, and the terminal device may receive the current location information of each unmanned aerial vehicle.

In some exemplary embodiments, for each sub-area block, after determining the target unmanned aerial vehicle for performing the to-be-performed task corresponding to the sub-area block, and further determining that the current location information of the target unmanned aerial vehicle meets the operating condition, the terminal device may send the to-be-performed task corresponding to the sub-area block to the target unmanned aerial vehicle; and after receiving the to-be-performed task, the target unmanned aerial vehicle may perform the task.

In some exemplary embodiments of the present disclosure, in the foregoing method, after the target unmanned aerial vehicle for performing the to-be-performed task corresponding to the sub-area block is determined, a route of the to-be-performed task may be determined, and location information of at least one key point on the route may be obtained. Based on a distance between the takeoff point of the target unmanned aerial vehicle and the at least one key point, whether the location information of the target unmanned aerial vehicle meets the operating condition is determined. If the location information of the target unmanned aerial vehicle meets the operating condition, the to-be-performed task corresponding to the sub-area block may be sent to the target unmanned aerial vehicle. If the location information of the target unmanned aerial vehicle does not meet the operating condition, the target unmanned aerial vehicle may move until the location of the target unmanned aerial vehicle meets the operating condition; or another target unmanned aerial vehicle may be reassigned for the sub-area block. In some exemplary embodiments of the present disclosure, when whether the location information of the target unmanned aerial vehicle meets the operating condition is determined, a distance between a point of other location information of the target unmanned aerial vehicle and the key point may be selected and used for determination. Specific settings may be performed based on actual task requirements, and are not limited herein.

In some exemplary embodiments, the route of the to-be-performed task may be preset before the target area block may be divided into the plurality of sub-area blocks, or may be set separately for each sub-area block after the target area block is divided into the plurality of sub-area blocks.

For example, a method of determining whether the location information of the target unmanned aerial vehicle meets the operating condition may include: separately calculating distances between the takeoff point of the target unmanned aerial vehicle and all the key points on the route of the to-be-performed task. When a distance between the takeoff point of the target unmanned aerial vehicle and at least one key point is shorter than a first distance, the location information of the target unmanned aerial vehicle meets the operating condition.

In some exemplary embodiments, the distance between the takeoff point of the target unmanned aerial vehicle and at least one key point is shorter than the first distance may include two cases. In a first case, when the distances between the takeoff point of the target unmanned aerial vehicle and all the key points are all shorter than the first distance, it may indicate that power of the target unmanned aerial vehicle may be sufficient for the target unmanned aerial vehicle to perform the task.

In a second case, when the distances between the takeoff point of the target unmanned aerial vehicle and only some of the key points are shorter than the first distance, it may indicate that distances between the takeoff point of the target unmanned aerial vehicle and some of the key points are longer than the first distance. In this case, first prompt information may be output, where the first prompt information may prompt the user that the target unmanned aerial vehicle may not complete all to-be-performed tasks corresponding to the sub-area block.

In some exemplary embodiments, when distances between the takeoff point of the target unmanned aerial vehicle and some of the key points are longer than the first distance, it may indicate that current power of the target unmanned aerial vehicle is insufficient for the unmanned aerial vehicle to fly over the whole route, that is, the entire task may not be completed. However, the to-be-performed task may still be sent to the target unmanned aerial vehicle, but in this case, the target unmanned aerial vehicle may only perform a part of the to-be-performed task and then needs to return. In this case, the first prompt information may be output to prompt the user to make a decision. Based on needs, the user may select the target unmanned aerial vehicle to continue performing the to-be-performed task corresponding to the sub-area, or may select another target unmanned aerial vehicle for the sub-area.

In some exemplary embodiments of the present disclosure, the method may further include: when the distances between the takeoff point of the target unmanned aerial vehicle and all the key points are longer than or equal to a second distance, it may indicate that the location information of the target unmanned aerial vehicle does not meet the operating condition. Thus, the to-be-performed task corresponding to the sub-area block is not sent to the target unmanned aerial vehicle, where the second distance is longer than the first distance.

In some exemplary embodiments, if the distances between the takeoff point of the target unmanned aerial vehicle and all the key points on the route of the to-be-performed task are longer than or equal to the second distance, it may indicate that current power of the target unmanned aerial vehicle is insufficient for the unmanned aerial vehicle to fly to a starting point or an ending point of the route of the to-be-performed task and that the operating condition is not met. In this case, second prompt information may be output, where the second prompt information may prompt the user that the target unmanned aerial vehicle may not perform the to-be-performed task corresponding to the sub-area block. In this case, the to-be-performed task corresponding to the sub-area block is not sent to the target unmanned aerial vehicle. For example, content of the second prompt information may include information such as “matching failure, task data is not sent” or “the distance is too long, task data is not sent”.

In some exemplary embodiments, the first distance and the second distance may be set based on factors such as a current battery life of the target unmanned aerial vehicle. For the same unmanned aerial vehicle, the second distance may be greater than the first distance. For different unmanned aerial vehicles, the corresponding first distance and second distance may be different. Specific values of the first distance and the second distance are not limited herein.

In some exemplary embodiments of the present disclosure, after the distances between the takeoff point of the target unmanned aerial vehicle and all the key points are calculated, all the distances may be weighted and summated based on preset weights to obtain a value of a weighted sum. If the weighted sum is shorter than a third distance, it may be determined that the location information of the target unmanned aerial vehicle meets the operating condition.

In some exemplary embodiments, the third distance may be set based on factors such as the current battery life of the target unmanned aerial vehicle. Based on different importance of different key points, different weights may be assigned to the distances between the takeoff point of the target unmanned aerial vehicle and the key points. Then whether the operating condition is met is determined based on a value obtained through weighted summation calculation. This determining method may have higher accuracy.

In the method for controlling cooperative operations of unmanned aerial vehicles according to some exemplary embodiments of the present disclosure, the terminal device may determine the plurality of sub-area blocks in the target area block, and for each of the plurality of sub-area blocks, the terminal device may determine the target unmanned aerial vehicle for performing the to-be-performed task corresponding to the sub-area block; and when the location information of the target unmanned aerial vehicle meets the operating condition, the terminal device may send the to-be-performed task corresponding to the sub-area block to the target unmanned aerial vehicle, so that the target unmanned aerial vehicle may perform the to-be-performed task. Further, the terminal device may control the plurality of unmanned aerial vehicles to perform multi-thread cooperative operations, and operation efficiency of the unmanned aerial vehicles during large-area operations may be improved. In addition, whether the target unmanned aerial vehicle meets the operating condition may be determined, so as to determine whether the target unmanned aerial vehicle is suitable for performing the to-be-performed task in the sub-area block. When the target unmanned aerial vehicle is too far away from the sub-area block and therefore is uncapable of completing the to-be-performed task corresponding to the sub-area block, the to-be-performed task corresponding to the sub-area block is not sent to the target unmanned aerial vehicle. In this way, the target unmanned aerial vehicle may be prevented from being assigned a task with a distance that is too long, and thus avoiding the situation in which the target unmanned aerial vehicle needs to return due to insufficient power or the like before reaching the task area. This not only avoids unnecessary waste of resources, but also improves operation efficiency.

For example, the key points may include at least one of the following: a starting point on the route, an ending point on the route, or a point at a specified position on the route.

The point at the specified position may be a point farthest away from the takeoff point of the target unmanned aerial vehicle on the route, or if the route has a specific shape, then the point at the specified position may be a point at a corner. For example, when the route is a triangle, the specified point may be a vertex of the triangle. Certainly, another point on the route may also be selected as the point at the specified position based on actual needs. Details are not limited herein.

In some exemplary embodiments of the present disclosure, the to-be-performed task may include a plurality of preset routes not being continuous with respect to each other.

When a to-be-performed task corresponding to a sub-area block has at least two discontinuous preset routes, the terminal device may assign one target unmanned aerial vehicle for each of the discontinuous preset routes. When the terminal device sends the to-be-performed task to a target unmanned aerial vehicle, the to-be-performed task may include route information corresponding to the target unmanned aerial vehicle. Thus, the plurality of determined target unmanned aerial vehicles may fly based on corresponding routes and perform the to-be-performed task. Further, in some exemplary embodiments, the preset routes of the to-be-performed task in the sub-area block correspond one-to-one to the unmanned aerial vehicles for performing the task.

When the unmanned aerial vehicle is performing a surveying and mapping task, to facilitate three-dimensional modeling, image data of a surveyed and mapped area needs to be obtained from different angles. In this case, a plurality of routes may be set in a sub-area block, and unmanned aerial vehicles may be assigned to fly on the plurality of routes to obtain image data. Further, one terminal device may be used to control the plurality of unmanned aerial vehicles to acquire image data from different angles, and efficiency of surveying and mapping may be improved significantly.

In some exemplary embodiments, when the to-be-performed task is a surveying and mapping task, the to-be-performed task may instruct a photographing apparatus carried on the target unmanned aerial vehicle to perform photographing at a specified angle. Further, after the terminal device sends the to-be-performed task to the target unmanned aerial vehicle, the target unmanned aerial vehicle may fly based on the preset route of the to-be-performed task, and may perform photo shooting at an angle specified by the to-be-performed task, and may return obtained image data to the terminal device at the same time.

For example, the specified angle of the photographing apparatus may include any specified angle within a range in which a pitch angle of the photographing apparatus is greater than or equal to −90° and less than 0°, and may include any one of the following: a pitch angle of −30°, a pitch angle of −45°, and a pitch angle of −60°.

In some exemplary embodiments of the present disclosure, when all the unmanned aerial vehicles that participate in task execution of the target area block being assigned tasks for the first time, every time a target unmanned aerial vehicle for performing a to-be-performed task of a sub-area block is determined for the sub-area block, the to-be-performed task of the sub-area block may be sent to the target unmanned aerial vehicle; or if the plurality of unmanned aerial vehicles that participate in task execution of the target area block is being assigned tasks of the target area block for the first time, after target unmanned aerial vehicles for performing to-be-performed tasks of the sub-area blocks are determined for all the sub-area blocks, the to-be-performed tasks corresponding to the sub-area blocks may be sent to the corresponding target unmanned aerial vehicles at the same time; or after to-be-performed tasks are determined for all the unmanned aerial vehicles, the tasks to be performed by all the unmanned aerial vehicles and corresponding to the sub-area blocks are separately sent to target unmanned aerial vehicles. Therefore, in some exemplary embodiments, a timing of sending the to-be-performed task corresponding to the sub-area block to the target unmanned aerial vehicle may be determined based on actual application situations, and is not limited herein.

When a to-be-performed task corresponding to a sub-area block includes at least two preset routes not being continuous with respect to each other, one target unmanned aerial vehicle may be assigned to each of the discontinuous preset routes, so that a plurality of target unmanned aerial vehicles may jointly perform the to-be-performed task corresponding to the sub-area block, where the preset routes of the to-be-performed task in the sub-area block correspond one-to-one to the unmanned aerial vehicles for performing the task. Therefore, operation efficiency of the unmanned aerial vehicles may be improved. Especially when the unmanned aerial vehicles are performing tasks such as surveying and mapping, the operation efficiency of the plurality of unmanned aerial vehicles simultaneously performing operations in the surveyed and mapped area may be significantly improved in comparison with the operation efficiency of a single unmanned aerial vehicle.

In some exemplary embodiments of the present disclosure, when a quantity of the sub-area blocks is greater than the quantity of unmanned aerial vehicles that participate in task execution of the target area block, after determining that an unmanned aerial vehicle has completed a task, if a task of a remaining sub-area block has not been performed yet, a target unmanned aerial vehicle may be selected from the unmanned aerial vehicles that have completed the task to perform the task of the remaining sub-area block.

In some exemplary embodiments, after the unmanned aerial vehicle completes the task and returns to the original takeoff point or the landing point, the unmanned aerial vehicle may be assigned a new task. In this way, a task execution process of the unmanned aerial vehicle may be separated from a task assignment process, and interference with task execution by task assignment for the unmanned aerial vehicle in the task execution process of the unmanned aerial vehicle may be avoided. In addition, the foregoing process of sending the to-be-performed task to the target unmanned aerial vehicle and the processes of performing tasks by other target unmanned aerial vehicles may be independent of each other. By way of performing operations by the unmanned aerial vehicles in turns, operation efficiency may be significantly improved.

In some exemplary embodiments of the present disclosure, the to-be-performed task of the sub-area block may be a spraying task. Further, the plurality of unmanned aerial vehicles for performing the task of the target area block in some exemplary embodiments may be plant protection unmanned aerial vehicles.

In some exemplary embodiments, the to-be-performed task used to indicate that an amount of liquid carried on the target unmanned aerial vehicle may be set based on at least one of: battery power of the target unmanned aerial vehicle, the distance between the target unmanned aerial vehicle and the key point, a flying speed of the target unmanned aerial vehicle, or a spraying speed.

In some exemplary embodiments of the present disclosure, the to-be-performed task of the sub-area block may be a surveying and mapping task. Further, the plurality of unmanned aerial vehicles for performing the task of the target area block in some exemplary embodiments may be surveying and mapping unmanned aerial vehicles.

In some exemplary embodiments of the present disclosure, the determining, from the plurality of unmanned aerial vehicles that participate in task execution of the target area block, of the target unmanned aerial vehicle for performing the to-be-performed task corresponding to the sub-area block may include:

obtaining pairing information input by the user for the sub-area block, recognizing an unmanned aerial vehicle identifier from the pairing information, and determining the unmanned aerial vehicle corresponding to the unmanned aerial vehicle identifier as the target unmanned aerial vehicle.

Further, in some exemplary embodiments, the user may input the pairing information for the sub-area block on the terminal device to assign the unmanned aerial vehicle to the sub-area block. There may be a plurality of ways to input pairing information, for example, inputting a number corresponding to an unmanned aerial vehicle selected by the user into a diagram of the sub-area block displayed on the terminal device, dragging an icon of an unmanned aerial vehicle to a sub-area block, or connecting and paring a selected unmanned aerial vehicle with a sub-area block by using a connection line.

The terminal device may recognize the unmanned aerial vehicle identifier from the pairing information based on user operations, and may determine the unmanned aerial vehicle corresponding to the unmanned aerial vehicle identifier as the target unmanned aerial vehicle. In some exemplary embodiments, the unmanned aerial vehicle identifier may be the number of the unmanned aerial vehicle, or may be the location information of the unmanned aerial vehicle, or the like. After the terminal device establishes a connection with the unmanned aerial vehicle, the terminal device may assign an identifier to each unmanned aerial vehicle participating in task execution, and then displays identifiers of all accessed unmanned aerial vehicles to the user. Thus, the user may directly pair the unmanned aerial vehicle identifier with the number of the sub-area block when assigning the unmanned aerial vehicle to the sub-area block.

In some exemplary embodiments of the present disclosure, the terminal device may receive working state information sent by the target unmanned aerial vehicle, and may output prompt information of the working state of the target unmanned aerial vehicle based on the information.

In some exemplary embodiments, the terminal device may output the prompt information of the working state information of the target unmanned aerial vehicle, so that the user may conveniently understand the current working state of the unmanned aerial vehicle.

For example, the working state information may include at least one of: location information, battery power information, a remaining pesticide quantity, positioning accuracy information, or current wind speed information.

FIG. 7 is a schematic structural diagram of an electronic device according to some exemplary embodiments of the present disclosure. Referring to FIG. 7, the electronic device may include at least one memory 702 and a processor 701. The at least one memory 702 may be connected to the processor 701 by a communications bus 703, and may be configured to store a computer instruction executable by the processor 701. The processor 701 may be configured to read the computer instruction from the memory to implement the following:

determining a plurality of sub-area blocks in a target area block, where a corresponding to-be-performed task is set for each sub-area block;

for the sub-area block, determining, from a plurality of unmanned aerial vehicles that participate in task execution of the target area block, a target unmanned aerial vehicle for performing the to-be-performed task corresponding to the sub-area block; and

when location information of the target unmanned aerial vehicle meets an operating condition, sending the to-be-performed task corresponding to the sub-area block to the target unmanned aerial vehicle, so that the target unmanned aerial vehicle performs the to-be-performed task.

In some exemplary embodiments, the processor 701 may be further configured to read the computer instruction from the memory to implement the following:

when a quantity of the sub-area blocks is greater than the quantity of unmanned aerial vehicles that participate in task execution of the target area block, after determining that an unmanned aerial vehicle has completed a task, if a task of a remaining sub-area block has not been performed yet, determining, from unmanned aerial vehicles that have completed the task, a target unmanned aerial vehicle to perform the task of the remaining sub-area block.

In some exemplary embodiments, the processor 701 may be further configured to read the computer instruction from the memory to implement the following:

determining a route of the to-be-performed task, and obtaining location information of at least one key point on the route.

In some exemplary embodiments, the location information of the target unmanned aerial vehicle meets the operating condition may include: a distance between a takeoff point of the target unmanned aerial vehicle and the at least one key point is shorter than a first distance.

In some exemplary embodiments, the location information of the target unmanned aerial vehicle does not meet the operating condition may include: distances between the takeoff point of the target unmanned aerial vehicle and all the key points are longer than or equal to a second distance, where the second distance is longer than the first distance; and

the processor 701 may be further configured to read the computer instruction from the memory to implement the following:

when the distances between the takeoff point of the target unmanned aerial vehicle and all the key points are longer than or equal to the second distance, not performing the step of sending the to-be-performed task corresponding to the sub-area block to the target unmanned aerial vehicle.

In some exemplary embodiments, the processor 701 may be further configured to read the computer instruction from the memory to implement the following:

when distances between the takeoff point of the target unmanned aerial vehicle and the at least one key point is shorter than the first distance, outputting first prompt information, where the first prompt information may prompt that the target unmanned aerial vehicle may not complete all to-be-performed tasks corresponding to the sub-area block.

In some exemplary embodiments, the processor 701 may be further configured to read the computer instruction from the memory to implement the following:

outputting second prompt information, where the second prompt information may prompt that the target unmanned aerial vehicle may not perform the to-be-performed task corresponding to the sub-area block.

In some exemplary embodiments, the location information of the target unmanned aerial vehicle meets the operating condition may further include: a weighted sum of distances between a takeoff point of the target unmanned aerial vehicle and the at least one key point is shorter than a third distance.

In some exemplary embodiments, the at least one key point may include at least one of the following: a starting point on the route, an ending point on the route, or a point at a specified position on the route.

In some exemplary embodiments, the to-be-performed task of the sub-area block may be a spraying task. The to-be-performed task may indicate that an amount of liquid carried on the target unmanned aerial vehicle is set based on at least one of: battery power of the target unmanned aerial vehicle, the distance between the target unmanned aerial vehicle and the key point, a flying speed of the target unmanned aerial vehicle, or a spraying speed.

In some exemplary embodiments, the to-be-performed task may include a plurality of preset routes not being continuous with respect to each other.

In some exemplary embodiments, the processor 701 may be further configured to read the computer instruction from the memory to implement the following:

determining one target unmanned aerial vehicle for each of the discontinuous preset routes.

In some exemplary embodiments, the to-be-performed task may include a surveying and mapping task.

In some exemplary embodiments, the to-be-performed task may instruct a photographing apparatus carried on the target unmanned aerial vehicle to perform photographing at a specified angle.

In some exemplary embodiments, the specified angle may include at least one of the following: a pitch angle of −30°, a pitch angle of −45°, or a pitch angle of −60°.

In some exemplary embodiments, the plurality of discontinuous preset routes may include two preset routes orthogonal to each other.

In some exemplary embodiments, the processor 701 may be further configured to read the computer instruction from the memory to implement the following:

simultaneously sending the to-be-performed tasks to target unmanned aerial vehicles corresponding to the tasks.

In some exemplary embodiments, the processor 701 may be further configured to read the computer instruction from the memory to implement the following:

sending a positioning mode confirmation instruction to the plurality of unmanned aerial vehicles that participate in task execution of the target area block, so that the unmanned aerial vehicle may confirm, after receiving the positioning mode confirmation instruction, whether a current positioning mode is a specified mode, and if no, adjusts the positioning mode to the specified mode.

In some exemplary embodiments, the specified mode may include a real-time kinematic positioning mode.

In some exemplary embodiments, the processor 701 may be further configured to read the computer instruction from the memory to implement the following:

obtaining pairing information input by a user for the sub-area block, recognizing an unmanned aerial vehicle identifier from the pairing information, and determining the unmanned aerial vehicle corresponding to the unmanned aerial vehicle identifier as the target unmanned aerial vehicle.

In some exemplary embodiments, the processor 701 may be further configured to read the computer instruction from the memory to implement the following:

receiving working state information sent by the target unmanned aerial vehicle, and outputting prompt information based on the working state information of the target unmanned aerial vehicle.

In some exemplary embodiments, the working state information of the target unmanned aerial vehicle may include at least one of: location information, battery power information, a remaining pesticide quantity, positioning accuracy information, or a current wind speed.

The electronic device provided in the some exemplary embodiments of the present disclosure may determine the plurality of sub-area blocks in the target area block, then may determine, for each of the plurality of sub-area blocks in the target area block, the target unmanned aerial vehicle for performing the task of the sub-area block, and may then send the task of the sub-area block to the target unmanned aerial vehicle, so that the target unmanned aerial vehicle may perform the task of the sub-area block. In this way, cooperative operations of the plurality of unmanned aerial vehicles may be implemented, and operation efficiency may be improved.

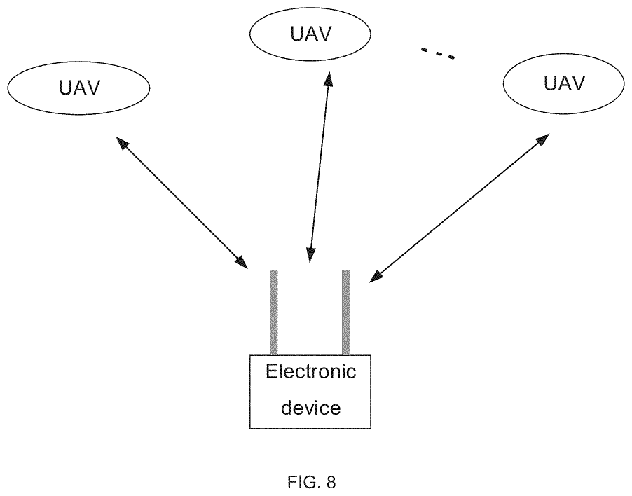

FIG. 8 is a schematic structural diagram of a system for controlling cooperative operations of unmanned aerial vehicles according to some exemplary embodiments of the present disclosure. Referring to FIG. 8, the system may include the electronic device according to any one of the foregoing embodiments and a plurality of unmanned aerial vehicles that participate in task execution of a target area block.

The electronic device may be configured to determine a plurality of sub-area blocks in a target area block, where a corresponding to-be-performed task may be set for each sub-area block. For the sub-area block, determine, from a plurality of unmanned aerial vehicles that participate in task execution of the target area block, a target unmanned aerial vehicle for performing the to-be-performed task corresponding to the sub-area block; and when location information of the target unmanned aerial vehicle meets an operating condition, send the to-be-performed task corresponding to the sub-area block to the target unmanned aerial vehicle.

The unmanned aerial vehicle may be configured to perform the to-be-performed task after receiving the to-be-performed task.

In the system for controlling cooperative operations of unmanned aerial vehicles according to some exemplary embodiments of the present disclosure, the electronic device may determine the plurality of sub-area blocks in the target area block, then may determine, for each of the plurality of sub-area blocks in the target area block, the target unmanned aerial vehicle for performing the task of the sub-area block, and may then send the task of the sub-area block to the target unmanned aerial vehicle; and after receiving the to-be-performed task sent by the electronic device, the target unmanned aerial vehicle may perform the task of the sub-area block. In this way, the electronic device may simultaneously control the plurality of unmanned aerial vehicles to perform cooperative operations, and operation efficiency may be improved.

In some embodiments of the present disclosure, a computer-readable storage medium is provided, where the computer-readable storage medium may store a computer program, and when the program is executed by a processor, steps of the method for controlling cooperative operations of unmanned aerial vehicles in any one of the foregoing exemplary embodiments may be implemented.

The method, electronic device, and system for controlling cooperative operations of unmanned aerial vehicles according to the foregoing exemplary embodiments of the present disclosure may be applied to unmanned aerial vehicles including, but not limited to, plant protection unmanned aerial vehicles or surveying and mapping unmanned aerial vehicles. A large target area block may be divided into a plurality of sub-area blocks, which is equivalent to dividing a task corresponding to the target area block into a plurality of to-be-performed tasks. After the plurality of sub-area blocks in the target area block are determined, for each of the plurality of sub-area blocks in the target area block, a target unmanned aerial vehicle for performing a to-be-performed task of the sub-area block may be determined. When location information of the target unmanned aerial vehicle meets an operating condition, the task of the sub-area block may be sent to the target unmanned aerial vehicle, and the target unmanned aerial vehicle may perform the to-be-performed task of the sub-area block. Further, in some exemplary embodiments of the present disclosure, the task of the target area block may be performed cooperatively by a plurality of unmanned aerial vehicles at the same time. This avoids disadvantages such as a short battery life and long operation time when a single unmanned aerial vehicle (such as a plant protection unmanned aerial vehicle and a surveying and mapping unmanned aerial vehicle) is used in a large working area. In addition, when the unmanned aerial vehicles are surveying and mapping unmanned aerial vehicles, the plurality of unmanned aerial vehicles may be used to acquire image data from different angles, and the image data acquired from different angles may be used for three-dimensional modeling, and the like, so that efficiency of modeling may be improved. In summary, the present disclosure may implement cooperative operations of the plurality of unmanned aerial vehicles, and may significantly improve operation efficiency.

Because the exemplary apparatus embodiments largely corresponds to the exemplary method embodiments, for the relevant part, kindly refer to the descriptions of the exemplary method embodiments. The described apparatus embodiments are merely exemplary. The units described as separate parts may or may not be physically separate, and parts displayed as units may or may not be physical units. The units may be located in one position, or may be distributed over a plurality of network elements. Some or all of the modules may be selected based on actual needs to achieve the objective of the solution of the exemplary embodiments. A person of ordinary skill in the art may understand and implement the solution of the exemplary embodiments without creative efforts.

It should be noted that the relational terms such as first and second in this specification are used only to differentiate an entity or operation from another entity or operation, and do not require or imply any actual relationship or sequence between these entities or operations. The terms “comprising”, “including”, or any other variants thereof are intended to cover a non-exclusive inclusion, so that a process, a method, an article, or a device that includes a list of elements not only includes those elements but also includes other elements that are not expressly listed, or further includes elements inherent to the process, method, article, or device. In absence of more constraints, an element preceded by “includes a . . . ” does not preclude existence of other identical elements in the process, method, article, or device that includes the element.

The method and apparatus provided in some exemplary embodiments of the present disclosure are described in detail above. The principles and implementations of the present invention are described herein by using some examples. The description of the exemplary embodiments is merely provided to help understand some methods and core ideas of the present disclosure. In addition, a person of ordinary skill in the art may make variations and modifications to the present disclosure in terms of the specific implementations and application scopes according to the idea of the present disclosure. Therefore, content of this disclosure shall not be construed as limiting.

What is claimed is:

1. A method for controlling cooperative operations of unmanned aerial vehicles, comprising:
determining a plurality of sub-area blocks in a target area block, wherein each of the plurality of sub-area blocks corresponds to a task;
for each of the plurality of sub-area blocks:
determining a target unmanned aerial vehicle, from a plurality of unmanned aerial vehicles, for performing the task corresponding to the sub-area block to complete, cooperatively with other unmanned aerial vehicles of the plurality of unmanned aerial vehicles, an overall task over the target area block; and
based on an operating condition associated with location information of the target unmanned aerial vehicle, sending or refraining from sending the task corresponding to the sub-area block to the target unmanned aerial vehicle.

2. The method according to claim 1, wherein after the determining of the target unmanned aerial vehicle from the plurality of unmanned aerial vehicles, the method further includes:
determining a route of the task, and
obtaining a plurality of key points on the route.

3. The method according to claim 2, wherein the sending or refraining from sending of the task corresponding to the sub-area block to the target unmanned aerial vehicle includes:
determining that a distance between a takeoff point of the target unmanned aerial vehicle and at least one key point of the plurality of key points is shorter than a first distance; and
sending the task corresponding to the sub-area block to the target unmanned aerial vehicle.

4. The method according to claim 3, wherein the sending or refraining from sending of the task corresponding to the sub-area block to the target unmanned aerial vehicle includes:
determining that distances between the takeoff point and all of the plurality of key points are longer than or equal to a second distance, wherein the second distance is longer than the first distance; and
refraining from sending the task to the target unmanned aerial vehicle.

5. The method according to claim 4, further including:
outputting second prompt, indicating that the target unmanned aerial vehicle is uncapable of performing the task.

6. The method according to claim 3, further including:
when at least one distance in the distances between the takeoff point of the target unmanned aerial vehicle and the plurality of key points is longer than the first distance, outputting first prompt information indicating that the target unmanned aerial vehicle is uncapable of completing all the task.

7. The method according to claim 2, wherein the sending or refraining from sending of the task corresponding to the sub-area block to the target unmanned aerial vehicle includes:
determining that a weighted sum of distances between a takeoff point of the target unmanned aerial vehicle and the plurality of key points is shorter than a third distance; and
sending the task corresponding to the sub-area block to the target unmanned aerial vehicle.

8. The method according to claim 2, wherein the plurality of key points includes at least one of:
a starting point on the route,
an ending point on the route, or
a point at a specified position on the route.

9. The method according to claim 2, wherein the task is a spraying task.

10. The method according to claim 1, wherein the task includes a plurality of preset routes being discontinuous with respect to each other.

11. The method according to claim 10, wherein the determining of the target unmanned aerial vehicle for performing the task corresponding to the sub-area block includes:
determining at least one target unmanned aerial vehicle for each of the plurality of preset routes.

12. The method according to claim 11, wherein the task includes a surveying and mapping task.

13. The method according to claim 12, wherein the task is configured to instruct a photographing apparatus mounted on the target unmanned aerial vehicle to perform photographing at a specified angle.

14. The method according to claim 13, wherein the specified angle includes at least one of: a pitch angle of −30°, a pitch angle of −45°, or a pitch angle of −60°.

15. The method according to claim 10, wherein the plurality of discontinuous preset routes includes two preset routes orthogonal to each other.

16. The method according to claim 1, wherein when all the plurality of unmanned aerial vehicles are unmanned aerial vehicles that receiving their respective tasks of the target area block for the first time, the method further comprising:
simultaneously sending other unmanned aerial vehicles in the plurality of unmanned vehicles their corresponding tasks simultaneously with the target unmanned aerial vehicle.

17. The method according to claim 1, wherein before the determining of the target unmanned aerial vehicle, the method includes:
sending a positioning mode confirmation instruction to the target unmanned aerial vehicle, so that the target unmanned aerial vehicle confirms, after receiving the positioning mode confirmation instruction, that a current positioning mode is a specified mode, and otherwise adjusts the positioning mode to the specified mode.

18. The method according to claim 17, wherein the specified mode includes a real-time kinematic positioning mode.

19. The method according to claim 1, wherein the determining of the target unmanned aerial vehicle includes:
obtaining pairing information input by a user for the sub-area block,
recognizing an unmanned aerial vehicle identifier from the pairing information, and
determining an unmanned aerial vehicle corresponding to the unmanned aerial vehicle identifier as the target unmanned aerial vehicle.

20. The method according to claim 1, further including:
receiving information sent by the target unmanned aerial vehicle representing a working state of the target unmanned aerial vehicle, and
outputting prompt information of the working state of the target unmanned aerial vehicle based on the information.
